(19) United States
(12) Patent Application Publication
(10) Pub. No.: US 2014/0023275 A1
(43) Pub. Date: Jan. 23, 2014

(54) REDUNDANT ASPECT RATIO DECODING OF DEVANAGARI CHARACTERS

(71) Applicant: QUALCOMM INCORPORATED, San Diego, CA (US)

(72) Inventors: Raj Kumar Krishna Kumar, Bangalore (IN); Pawan Kumar Baheti, Bangalore (IN)

(73) Assignee: QUALCOMM INCORPORATED, San Diego, CA (US)

(21) Appl. No.: 13/844,641

(22) Filed: Mar. 15, 2013

Related U.S. Application Data
(60) Provisional application No. 61/673,698, filed on Jul. 19, 2012.

(51) Int. Cl. G06K 9/58

(52) U.S. Cl. CPC G06K 9/58
USPC 382/182

(57) ABSTRACT

An electronic device and method receive a block sliced from a rectangular portion of an image of a scene of real world captured by a camera and use a property of the block to operate one of multiple optical character recognition (OCR) decoders. In an illustrative aspect, a first OCR decoder is configured to recognize characters whose property satisfies the test based on a first limit, the first limit being obtained by reducing a predetermined limit by an overlap amount. In this illustrative aspect, a second OCR decoder is configured to recognize characters whose property does not satisfy the test based on a second limit, the second limit being obtained by increasing the predetermined limit by the overlap amount. When the property of the block satisfies the test, the first OCR decoder is operated and alternatively the second OCR decoder is operated, resulting in candidates for a character being identified.

### CROSS-REFERENCE TO PROVISIONAL APPLICATIONS

This application claims priority under 35 USC §119(e) from U.S. Provisional Application No. 61/673,698 filed on Jul. 19, 2012 and entitled “REDUNDANT ASPECT RATIO DECODING OF DEVANAGARI CHARACTERS”, which is assigned to the assignee hereof and which is incorporated herein by reference in its entirety.

### CROSS-REFERENCE TO US APPLICATIONS INCORPORATED BY REFERENCE

This application is related to U.S. application Ser. No. 13/829,960 filed on Mar. 14, 2013 and entitled “Trellis based word decoder with reverse pass”, which is assigned to the assignee hereof and which is incorporated herein by reference in its entirety.

This application is related to U.S. application Ser. No. 13/791,188 filed on Mar. 8, 2013 and entitled “Lower Modifier Detection and Extraction From Devanagari Text Images To Improve OCR Performance”, which is assigned to the assignee hereof and which is incorporated herein by reference in its entirety.

This application is related to U.S. application Ser. No. 13/789,549 filed on Mar. 7, 2013 and entitled “Feature Extraction And Use With A Probability Density Function (PDF) Divergence Metric”, which is assigned to the assignee hereof and which is incorporated herein by reference in its entirety.

### FIELD

This patent application relates to devices and methods for identifying in natural images or video frames, words of text by using multiple OCR decoders that redundantly decode normal characters and conjunct characters.

BACKGROUND

Identification of text regions in papers that are optically scanned (e.g. by a flatbed scanner of a photocopier) is significantly easier (e.g. due to upright orientation, large size and slow speed) than detecting regions that may contain text in scenes of the real world that may be captured in images (also called “natural images”) or in video frames in real time by a handheld device (such as a smartphone) having a built-in digital camera. Specifically, optical character recognition (OCR) methods of the prior art originate in the field of document processing, wherein the document image contains a series of lines of text (e.g. 20 lines of text) of an optically scanned page in a document. Document processing techniques, although successfully used on scanned documents created by optical scanners, generate too many false positives and/or negatives so as to be impractical when used on natural images containing text e.g. on traffic signs, store fronts, vehicle license plates, due to variations in lighting, color, tilt, focus, font, etc.

FIG. 1A illustrates a bill board in the real world scene 100 in India. A user 110 (see FIG. 1B) may use a camera-equipped mobile device (such as a cellular phone) 108 to capture an image 107 (also called “natural image” or “real world image”) of scene 100. Camera captured image 107 may be displayed on a screen 106 of mobile device 108. Such an image 107 (FIG. 1A), if processed directly using prior art image processing techniques may result in failure to recognize one or more words in a region 103 (FIG. 1A). Specifically, use of prior art methods can cause problems when used with words that contain conjunct characters, in text expressed in the language Hindi.

For example, in a predetermined language, such as the Hindi language, while a normal character (e.g. a single vowel or consonant) of the type shown in FIG. 1B may be easily recognized by an appropriately trained OCR decoder, the character set of the Devanagari alphabet includes compound (or conjunct) characters. Specifically, a letter 151 may be joined with another letter 152 (FIG. 1C) to obtain a conjunct (or compound) character 153 (FIG. 1D). Such a conjunct (or compound) character may be present in an image of a word, as shown in region 103 of image 107 (FIG. 1A), with the second character therein being a conjunct character. As there are 34 consonants in the Devanagari alphabet, there are at least 34×34=1156 compound characters. Training an OCR system to recognize over 1000 characters results in a very complex system with a poor recall accuracy.

Accordingly, there is a need to improve identification of Devanagari characters in blocks of in a natural image or video frame, as described below.

### SUMMARY

In several aspects of described embodiments, an electronic device and method use a camera to capture an image of a scene of real world outside the electronic device, followed by identifying rectangular portions of the image that are likely to contain text. A property of a block sliced from a rectangular portion is used to select and operate one of multiple optical character recognition (OCR) decoders.

In an illustrative embodiment, a first OCR decoder is configured to recognize characters (such as normal characters) whose property does not satisfy a test based on a first limit (e.g. on an aspect ratio), the first limit being obtained by increasing a predetermined limit by an overlap amount. In the illustrative aspect, a second OCR decoder is configured to recognize characters (such as a compound character) whose property satisfies the test based on a second limit (e.g. also on aspect ratio), the second limit being obtained by reducing a predetermined limit by the overlap amount. When the property (e.g. aspect ratio) of the block does not satisfy the test, the first OCR decoder is operated (e.g. to detect normal characters). When the property of the block satisfies the test, the second OCR decoder is operated (e.g. to detect compound characters). Multiple alternative candidates (e.g. characters) for the block identified by operation of the first OCR decoder or by operation of the second OCR decoder and associated probabilities are added to a first hypothesis. Moreover, when the property of the block satisfies the test, additionally the first OCR decoder may be additionally operated to create an additional hypothesis (e.g. second hypothesis) by making copies of candidates (e.g. characters) in the first hypothesis and associated probabilities, and adding candidates (e.g. characters) identified by additionally operating the first OCR decoder. The first hypothesis and the second or additional hypotheses are stored in memory, for use by a word decoder. The word decoder is operated multiple times, to select a word for each hypothesis, and provide an indication of confidence in the selected word. The indication of confidence is thereafter used to select one hypothesis and its selected word is identified as a word recognized in the image.

It is to be understood that several other aspects of the described embodiments will become readily apparent to those skilled in the art from the description herein, wherein it is shown and described various aspects by way of illustration. The drawings and detailed description below are to be regarded as illustrative in nature.

### BRIEF DESCRIPTION OF THE DRAWINGS

FIG. 1A illustrates a user using a camera-equipped mobile device of the prior art to capture an image of a bill-board in the real world.

FIG. 1B illustrates a first character of the prior art, in a rectangular portion 103 of the image 107 of FIG. 1A.

FIG. 1C illustrates two consonants 151 and 152 of the Devanagari alphabet of the prior art.

FIG. 1D illustrates a compound (or conjunct) character formed in the prior art by combination of a pair of consonants as follows: a left-most part (or a left half) of first consonant 151 is combined with a second consonant 152 in FIG. 1C.

FIGS. 2A and 2B illustrate, in flow charts, acts performed by one or more processors in several described embodiments, to recognize a word.

FIGS. 3A-3C illustrate configuration of OCR decoders for use in identifying compound and normal characters of the Devanagari alphabet in some embodiments.

FIG. 4 illustrates, in a flow chart, acts performed in several described embodiments, to identify characters in a block in a rectangular portion of a natural image.

FIG. 5 illustrates, in a high-level block diagram, various components of a handheld device in some of the described embodiments.

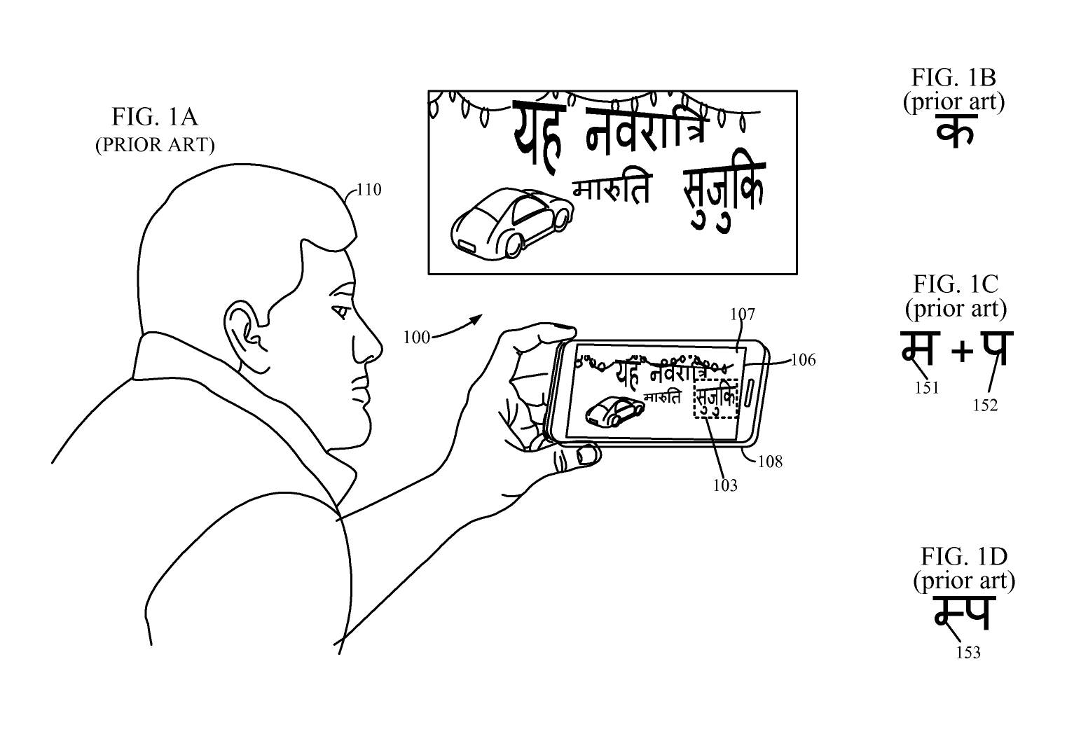

### DETAILED DESCRIPTION

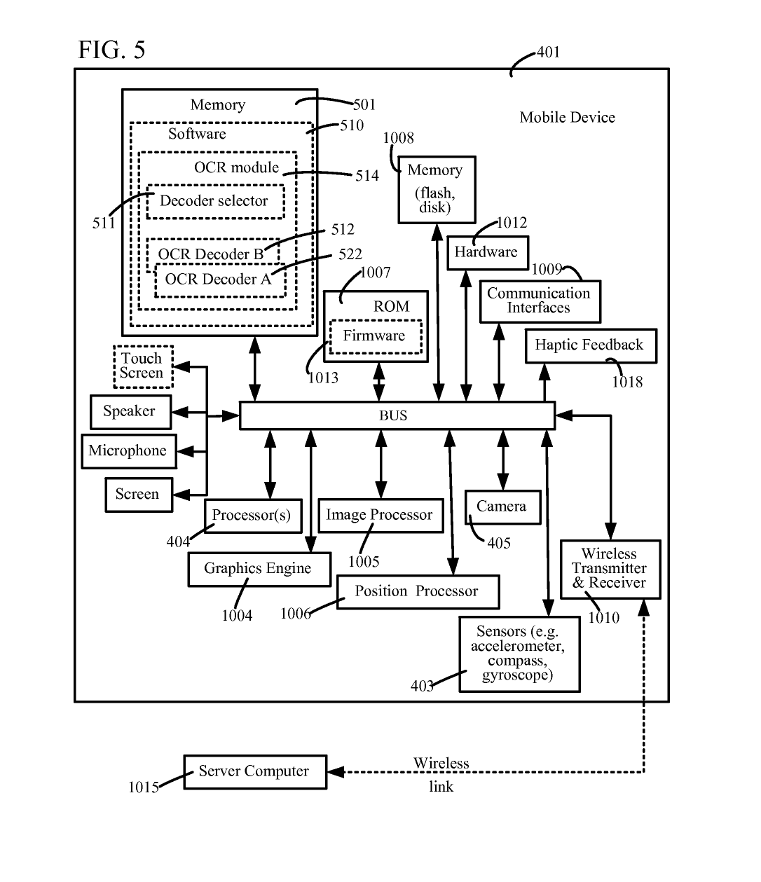

Several operations and acts of the type described herein are implemented by one or more processors, such as processor 404 included in a mobile device 401 (FIG. 5) that is capable of identifying rectangular portions of an image of a real world scene, followed by segmentation of each rectangular portion to form blocks and identify characters therein. Hence, mobile device 401 may include a camera 405 (FIG. 5) to generate an image or frames of a video of a scene in the real world. Mobile device 401 may further include sensors, such as accelerometers, gyroscopes, GPS sensor or the like, which may be used to assist in determining the pose (including position and orientation) of the mobile device 401 relative to a real world scene.

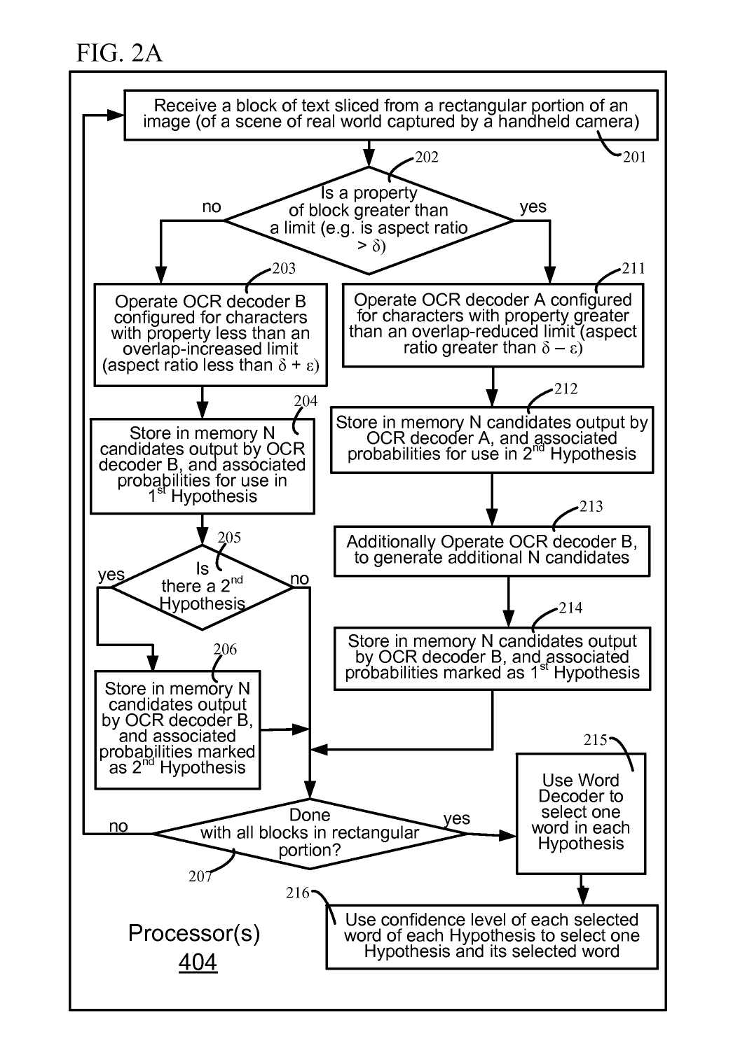

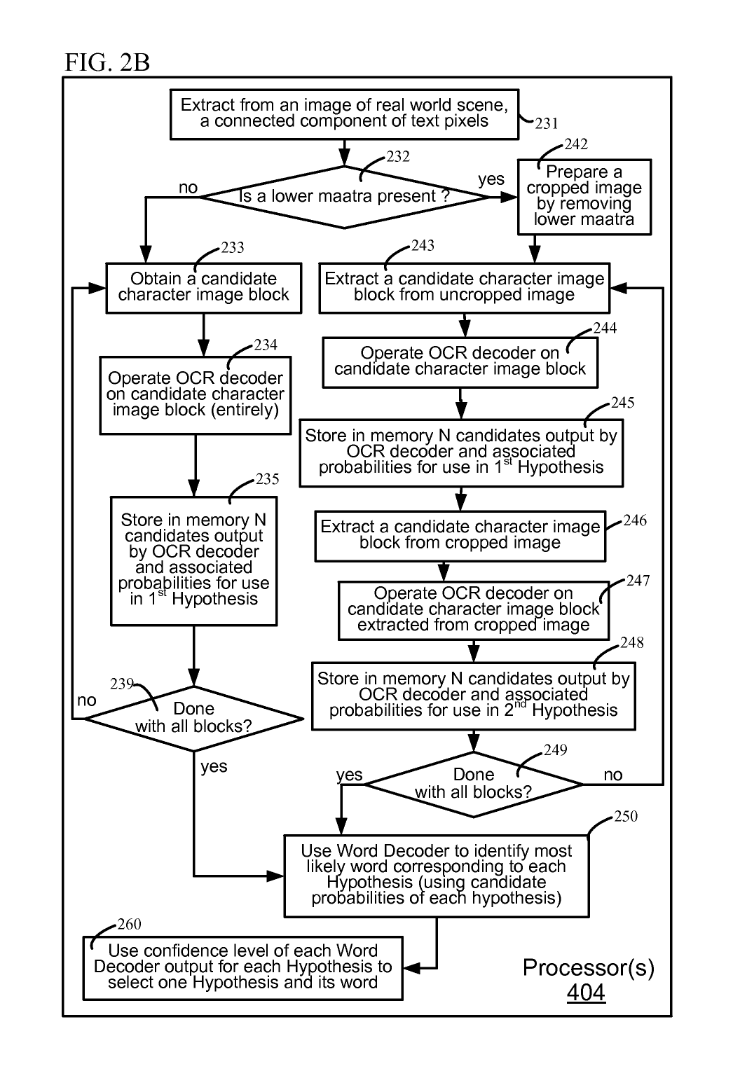

Accordingly, as per act 201 in FIG. 2A, one or more processors, such as processor 404 typically receives (e.g. from memory 501, see FIG. 5) a block that has been sliced from a rectangular portion of an image of a scene of real world captured by camera 405. The rectangular portion may be identified by such a processor 404 using any method that identifies from the image, one or more regions (also called “blobs”) that differ from surrounding pixels in one or more properties, such as intensity and/or color. Regions of the type described above may be similar or identical to regions known in the prior art as maximally stable external regions or MSERs. A block segmented from a rectangular portion that includes such a region is received in act 201 and processed as follows.

As per act 202 in FIG. 2A, at least one processor, such as processor 404 checks whether a property of the block satisfies a test that is based on a predetermined limit. One example of a property of the block that may be used in act 202 is aspect ratio, namely the ratio length of block/height of block. Another example of such a property is a ratio of a number of pixels in the region to the left of a vertical line in the block to a number of pixels in the region to the right of the vertical line. Hence, any geometric property of the block may be used in the check performed in act 202. Note that the limit used in act 202 is predetermined, based on the property used in the test.

In act 202, when the property of the block is found to satisfy the test, then the yes branch is taken to act 211 and alternatively the no branch is taken to act 203. In act 203, the processor 404 operates an optical character recognition (OCR) decoder B that has been configured ahead of time to recognize characters whose property does not satisfy the test based on a limit (also called “increased” limit) which is different from the predetermined limit used in act 202. The increased limit used in act 203 is obtained by increasing a predetermined limit of act 202 by an overlap amount which is itself a predetermined amount. The overlap amount is indicative of overlap between inputs accepted by OCR decoder B and another OCR decoder A that is used in act 211. Specifically, in act 211, the processor 404 operates OCR decoder A which is configured, ahead of time, to recognize characters whose property satisfies the test based on another limit (also called “reduced” limit). Specifically, the reduced limit used in act 211 is obtained by reducing the predetermined limit of act 202 by the predetermined amount (also called “overlap” amount).

After act 203, processor 404 performs an act 204 to store in a data structure in memory 501 used for a first hypothesis, a number N of candidates (for recognition, as occurring in the block) that have been identified by operation of OCR decoder B. Thereafter, processor 404 performs an act 205 to check whether there is a second hypothesis and if so goes to act 206 wherein processor 404 stores in a data structure in memory 501 used for the second hypothesis, a number N of candidates (for recognition, as occurring in the block) that have been identified by operation of OCR decoder B. After act 206 (and also if the answer in act 205 is no), processor 404 performs an act 207 to check whether all blocks in the rectangular portion have been processed and if not, processor 404 returns to act 201 (described above). When processor 404 finds in act 207 that all blocks have been processed, then control transfers to act 215, wherein a word decoder is used multiple times, once for each hypothesis, to select one word in each hypothesis and to output a confidence level for the selected word. Thereafter, processor 404 performs an act 216, by comparing the confidence levels of selected words in the multiple hypothesis to identify a single hypothesis and to identify the selected word of the identified hypothesis as a word recognized in the image. Some embodiments of the type described herein use a word decoder of the type described in U.S. application Ser. No. 13/829,960 entitled “Trellis based word decoder with reverse pass”, that is incorporated by reference above.

In act 202, when the property of the block is found to satisfy the test and the yes branch is taken to act 211. As noted above, in act 211, the processor 404 operates an optical character recognition (OCR) decoder A configured to recognize characters whose property satisfies the test based on the reduced limit). After completion of act 211 another act 212 is performed. Specifically, in act 212, processor 404 stores a number N of candidates that have been identified by operation of OCR decoder A and the associated probabilities, for use in a second hypothesis. Thereafter, in another act 213, processor 404 additionally operates OCR decoder B, to generate N candidates for use in an additional hypothesis, e.g. a second hypothesis. Subsequently, in act 214, processor 404 stores a number N of candidates that have been identified by operation of OCR decoder B and the associated probabilities, for use in the first hypothesis. On completion of act 214, control transfers to act 207, wherein processor 404 checks if all blocks in the rectangular portion have processed and if not returns to act 201, as noted above and if all blocks have been processed then acts 215 and 216 are performed as also noted above.

Although only one second hypothesis has been described above in reference to the method of FIG. 2A, in some embodiments multiple second hypotheses are formed e.g. each time that the “yes” branch is taken from act 202. However such embodiments require more computational resources and more memory than use of a single second hypothesis (with a first hypothesis), as illustrated in FIG. 2A and described above. Moreover, although use of multiple hypotheses has been described above in reference to two character decoders used in some embodiments, other embodiments may additionally or alternatively use multiple hypotheses in other ways. For example, multiple inputs are used to form multiple hypotheses as illustrated in FIG. 2B and described next.

Accordingly, as per act 231 in FIG. 2B, one or more processors, such as processor 404 extracts, from an image of a scene in real world, a connected component of text pixels. Then, in act 232, processor 404 checks whether a lower maatra is present (e.g. based on sparseness of pixels within a predetermined region, such as bottom ⅓^{rd} of the block).

Some embodiments check for lower maatra presence as described in, for example, U.S. application Ser. No. 13/791,188, entitled “Lower modifier detection and extraction from Devanagari text images to improve OCR performance” incorporated by reference above. Moreover, some embodiments implement OCR decoders which as described in, for example, U.S. application Ser. No. 13/789,549 entitled “Feature Extraction And Use With A Probability Density Function (PDF) Divergence Metric”, incorporated by reference above.

If the answer is no, processor 404 goes to act 233 to obtain a block which is likely to be a character of text (also called “candidate character image block”). Therafter in act 234, processor 404 operates an optical character recognition (OCR) decoder on the candidate character image block (in its entirety), and subsequently goes to act 235. In act 235, processor 404 stores in a data structure in memory 501 used for a first hypothesis, a number N of candidates (for recognition, as occurring in the block) that have been identified by operation of OCR decoder in act 234. Thereafter, processor 404 performs an act 239 to check whether all blocks of the connected component (extracted in act 231) have been processed and if not, processor 404 returns to act 233 (described above). When processor 404 finds in act 239 that all blocks have been processed, then control transfers to act 250, wherein a word decoder is used multiple times, once for each hypothesis, to select one word in each hypothesis and to output a confidence level for the selected word. Thereafter, processor 404 performs an act 260, by comparing the confidence levels of selected words in the multiple hypothesis to identify a single hypothesis and to identify the selected words of the identified hypothesis as a word recognized in the image.

In act 232, when no lower maatra is found to be present, then processor 404 goes to act 242 to prepare a cropped version (also called “cropped image”) of the connected component (also called “uncropped image”), e.g. by removing any lower maatra(s) that may be present. Thereafter, processor 404 performs an act 243 to extract a candidate character image block, from the uncropped image, and thereafter performs act 244. In act 244, processor 404 operates an optical character recognition (OCR) decoder on the candidate character image block, and goes to act 245. In act 245, processor 404 stores a number N of candidates that have been identified (by operation of OCR decoder in act 244), and the associated probabilities, for use in the first hypothesis. Thereafter, in another act 246, processor 404 extracts a candidate character image block, from the cropped image, and thereafter performs act 247.

In act 247, processor 404 operates an optical character recognition (OCR) decoder on the candidate character image block, and goes to act 248. In act 248, processor 404 stores a number N of candidates that have been identified (by operation of OCR decoder in act 247), and the associated probabilities, for use in a second hypothesis. On completion of act 248, control transfers to act 249, wherein processor 404 checks if all blocks in the rectangular portion have processed and if not returns to act 243, as noted above. When all blocks are processed, then control transfers from act 249 to act 250, followed by act 260 (both described above).

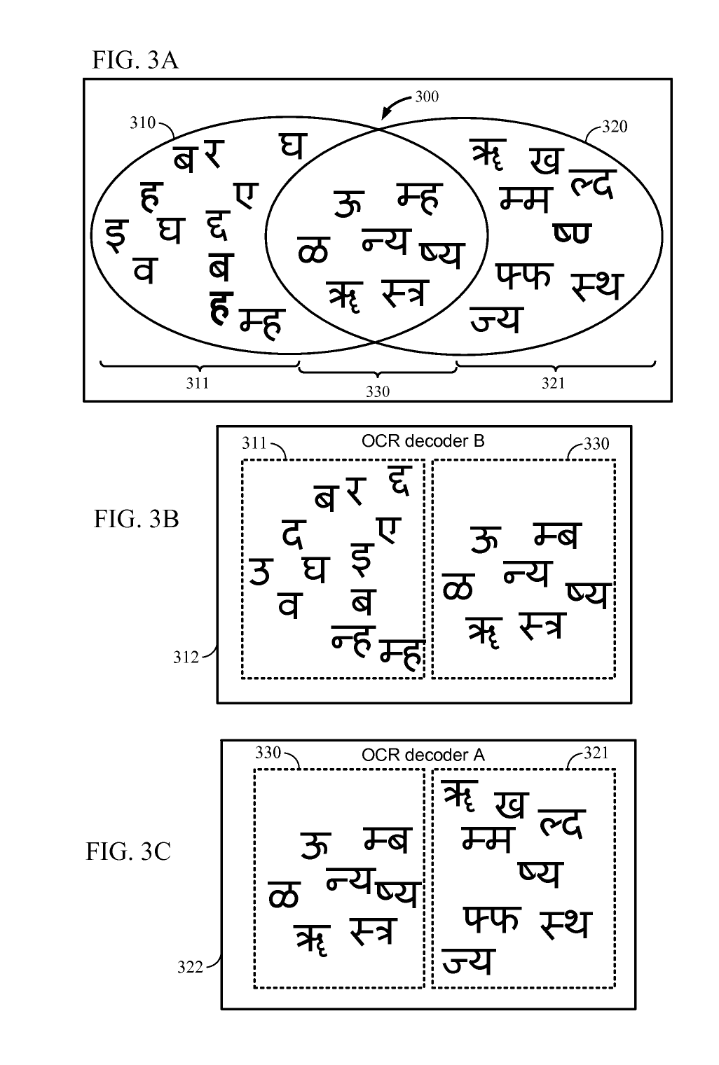

In an illustrative embodiment, processor 404 is programmed to use characters (both normal and compound) of the Devanagari alphabet, grouped into two sets 310 and 320 as follows. Set 310 (FIG. 3A) includes all characters with aspect ratio less than δ+ε, wherein δ is the predetermined limit (e.g. of value 1.2) and ε is the overlap amount (e.g. of value 0.1). Set 320 (FIG. 3A) includes all characters with aspect ratio greater than δ−ε. Both sets 310 and 320 include a common subset 330 which depends on the overlap amount ε.

In this illustrative embodiment, OCR decoder B is configured to recognize normal characters in subset 311 with the addition of a limited number of compound characters in subset 330 as illustrated in FIG. 3B. Hence, a majority of characters recognized by OCR decoder B are normal characters. Similarly, OCR decoder A is configured to recognize compound characters in subset 321 with the addition of a limited number of the normal characters in subset 330 as illustrated in FIG. 3C. Therefore, a majority of characters recognized by OCR decoder A are compound characters.

Use of two different OCR decoders A and B as described above ensures that recognition of compound characters does not come at the price of sacrificing the detection accuracy of normal characters and vice versa. Moreover, use of the overlap amount ε ensures that OCR decoders A and B are cross-trained to perform the functions of one another to handle any misclassifications between compound characters and normal characters that may occur, for example due to presence of a few compound characters that have aspect ratios smaller than δ and a few normal characters that have aspect ratios larger than δ. As each of the two OCR decoders A and B is configured to recognize fewer characters than the entire Devanagari alphabet, accuracy of recognition is significantly improved.

In some embodiments, the values of δ and ε are determined empirically as follows. A first graph is drawn (e.g. manually) of a number of normal characters along a first axis v/s aspect ratio along a second axis. A second graph is additionally drawn, of number of compound characters along the first axis v/s aspect ratio along the second axis. A position at which tails of the two graphs intersect identifies the value of δ. The amount of overlap between the two tails identifies the value of ε. Note that δ and ε may be determined differently in other embodiments. In this manner, a predetermined limit δ and an overlap amount ε between two OCR decoders may be identified based on an intersection between: a first graph of a number of normal characters along a first axis v/s aspect ratio along a second axis and a second graph of number of compound characters along the first axis v/s aspect ratio along the second axis.

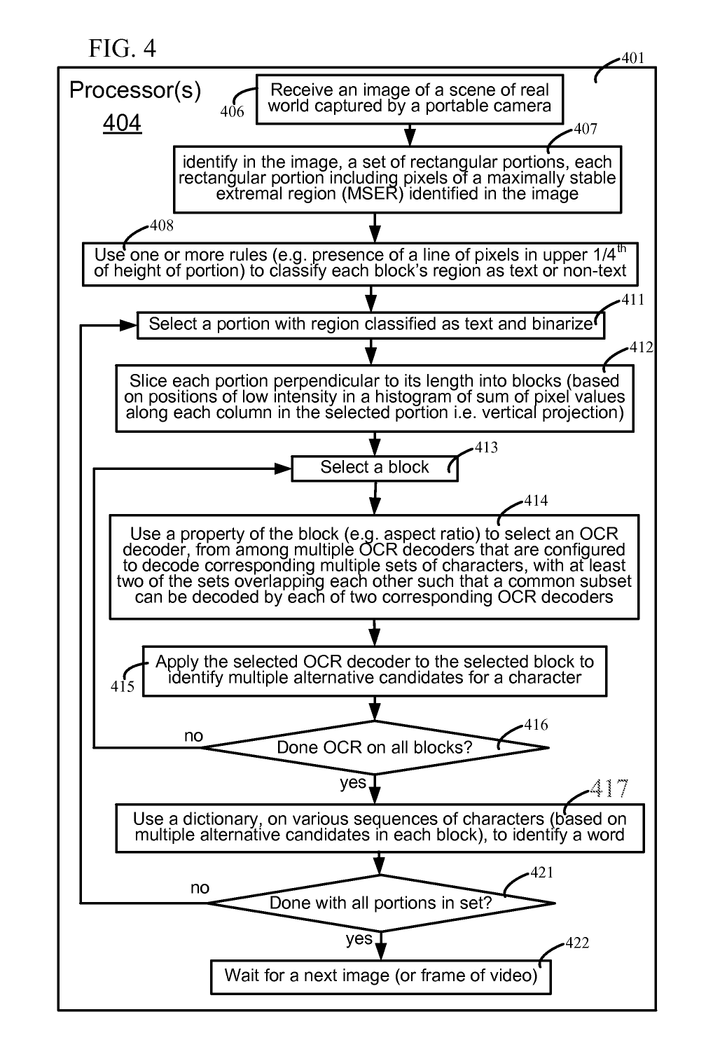

A method performed by processor 404 of some embodiments is illustrated in FIG. 4 and described next. Specifically, in act 406, processor 404 receives an image of a scene of the real world from a portable camera, such as a camera in a mobile device (e.g. a cell phone). Subsequently, in act 407, processor 404 identifies in the received image, a set of rectangular portions by use of any method that identifies connected components. For example, as noted above, any MSER method may be used in act 407, depending on the embodiment. Thereafter, in act 408, processor 404 uses one or more rules (e.g. the presence of a line of pixels for at least three-fourths of the length of a portion) to classify each portion's region as text or non-text.

Then a set of acts 411-419 is performed, on each portion of the image whose region (MSER) has been classified as text. Specifically, in act 411, such a portion is binarized, followed by act 412 wherein the portion is sliced into blocks. In some embodiments, processor 404 creates blocks based on positions of low intensity in a histogram of sum of pixel values along each column in the portion, i.e. a vertical projection. Next, a set of acts 413-416 are performed for each block that has just been created, as follows.

Specifically, in some embodiments, in an act 413, processor 404 selects a block and in act 414 uses a property of the block to select an OCR decoder, from among OCR decoders 512, 522 (FIG. 5) that have been configured ahead of time, to decode corresponding multiple sets of characters. Accordingly, in performing the act 413, processor 404 of some embodiments executes a decoder selector 511 which is included in OCR module 514 illustrated in FIG. 5.

As noted above, in certain embodiments, at least two of the just-described sets overlap each other such that a common subset can be decoded by each of two corresponding OCR decoders. Note, however, that in alternative embodiments there may be no common subset, e.g. when the value of the overlap amount ε is zero. An example of such an alternative embodiment uses three OCR decoders, with a first OCR decoder being used for blocks having a horizontal line of pixels therein, a second OCR decoder being used for blocks having a vertical line of pixels therein but no horizontal line of pixels, and a third OCR decoder being used for blocks having no horizontal line of pixels and no vertical line of pixels.

Next, in act 415, processor 404 applies the selected OCR decoder to the selected block, to identify multiple alternative candidates for a character in the selected block and stores them in memory 501 which also holds the software 510 that includes OCR module 514. Then, in act 416, processor 404 checks whether OCR has been performed on all blocks and if not returns to act 413 described above. If OCR has been performed, then processor 404 goes from act 416 to act 417. In operation 420, processor 404 uses a dictionary on various sequences of characters that are formed based on multiple alternative candidates in each block, to identify a word. Then in act 421, processor 404 checks if all portions in the set of portions identified in the image(in act 402) have been processed and if not returns to act 411 (described above), and if the answer is yes goes to act 422 to await receipt of another image or frame of video.

Mobile device 401 (FIG. 5) of some embodiments that performs the method shown in FIG. 2 is a mobile device, such as a smartphone that includes a camera 405 (FIG. 5) of the type described above to generate an image of a real world scene that is then processed to identify any characters of Devanagari alphabet therein. As noted above, mobile device 401 may further include sensors 403 that provide information on movement of mobile device 401, such as an accelerometer, a gyroscope, a compass, or the like. Mobile device 401 may use an accelerometer and a compass and/or other sensors to sense tilting and/or turning in the normal manner, to assist processor 404 in determining the orientation and position of a predetermined symbol in an image captured in mobile device 401. Instead of or in addition to sensors 403, mobile device 401 may use images from a camera 405 to assist processor 404 in determining the orientation and position of mobile device 401 relative to the predetermined symbol being imaged.

Also, mobile device 401 may additionally include a graphics engine 1004 and an image processor 1005 that are used in the normal manner. Mobile device 401 may optionally include OCR module 514 (e.g. implemented by one or more processor(s) 404 executing the software 510 in memory 501) to identify characters of text in blocks received as input by OCR module 514 (when software therein is executed by processor 404).

In addition to memory 501, mobile device 401 may include one or more other types of memory such as flash memory (or SD card) 1008 and/or a hard disk and/or an optical disk (also called “secondary memory”) to store data and/or software for loading into memory 501 (also called “main memory”) and/or for use by processor(s) 404. Mobile device 401 may further include a wireless transmitter and receiver in transceiver 1010 and/or any other communication interfaces 1009. It should be understood that mobile device 401 may be any portable electronic device such as a cellular or other wireless communication device, personal communication system (PCS) device, personal navigation device (PND), Personal Information Manager (PIM), Personal Digital Assistant (PDA), laptop, camera, smartphone, tablet (such as iPad available from Apple Inc) or other suitable mobile platform that is capable of creating an augmented reality (AR) environment.

A mobile device 401 of the type described above may include other position determination methods such as object recognition using “computer vision” techniques. The mobile device 401 may also include means for remotely controlling a real world object which may be a toy, in response to user input on mobile device 401 e.g. by use of transmitter in transceiver 1010, which may be an IR or RF transmitter or a wireless a transmitter enabled to transmit one or more signals over one or more types of wireless communication networks such as the Internet, WiFi, cellular wireless network or other network. The mobile device 401 may further include, in a user interface, a microphone and a speaker (not labeled). Of course, mobile device 401 may include other elements unrelated to the present disclosure, such as a read-only-memory 1007 which may be used to store firmware for use by processor 404.

Also, depending on the embodiment, a mobile device 401 may perform reference free tracking and/or reference based tracking using a local detector in mobile device 401 to detect characters of text in images, in implementations that operate the OCR module 514 to identify, e.g. characters of Devanagari alphabet in an image. Any one or more of above-described OCR decoders 512 and 522 and decoder selector 511 may be implemented in software (executed by one or more processors or processor cores) or in hardware or in firmware, or in any combination thereof.

In some embodiments of mobile device 401, functionality in the above-described OCR module 514 is implemented by a processor 404 executing the software 510 in memory 501 of mobile device 401, although in other embodiments such functionality is implemented in any combination of hardware circuitry and/or firmware and/or software in mobile device 401. Hence, depending on the embodiment, various functions of the type described herein may be implemented in software (executed by one or more processors or processor cores) or in dedicated hardware circuitry or in firmware, or in any combination thereof.

Accordingly, depending on the embodiment, any one or more of OCR module 514 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

Hence, methodologies described herein may be implemented by various means depending upon the application. For example, these methodologies may be implemented in firmware 1013 (FIG. 5) or software 510, or hardware 1012 or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. For a firmware and/or software implementation, the methodologies may be implemented with modules (e.g., procedures, functions, and so on) that perform the functions described herein.

Any non-transitory machine-readable medium tangibly embodying software instructions (also called “computer instructions”) may be used in implementing the methodologies described herein. For example, software 510 (FIG. 5) may include program codes (including a plurality of computer instructions) stored in memory 501 and executed by processor 404. Memory may be implemented within or external to the processor 404. If implemented in firmware and/or software, the functions may be stored as one or more instructions or code on a non-transitory computer-readable medium. Examples include non-transitory computer-readable media encoded with a data structure and non-transitory computer-readable media encoded with a computer program.

Non-transitory computer-readable media includes physical computer storage media. A non-transitory storage medium may be any available non-transitory medium that can be accessed by a computer. By way of example, and not limitation, such non-transitory computer-readable media can comprise RAM, ROM, Flash Memory, EEPROM, CD-ROM or other optical disk storage, magnetic disk storage or other magnetic storage devices, or any other non-transitory medium that can be used to store program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

Although several embodiments are described for instructional purposes, the embodiments are not limited thereto. Hence, although mobile device 401 shown in FIG. 5 of some embodiments is a mobile device, in other embodiments the mobile device 401 can be any item or device is implemented by use of form factors that are different, e.g. in certain other embodiments the item is a mobile platform (such as a tablet, e.g. iPad available from Apple, Inc.) while in still other embodiments the item is any electronic device or system. Illustrative embodiments of such an electronic device or system may include multiple physical parts that intercommunicate wirelessly, such as a processor and a memory that are portions of a stationary computer, such as a lap-top computer, a desk-top computer, or a server computer communicating over one or more wireless link(s) with sensors and user input circuitry enclosed in a housing of mobile device 401 (FIG. 5) that is small enough to be held in a hand.

Depending on a specific symbol recognized in a handheld camera captured image, a user can receive different types of feedback depending on the embodiment. Additionally haptic feedback (e.g. by vibration of mobile device 401) is provided by triggering haptic feedback circuitry 1018 (FIG. 5) in some embodiments, to provide feedback to the user when text is recognized in an image. Instead of the just-described haptic feedback, audio feedback may be provided via a speaker in mobile device 401, in other embodiments.

Several embodiments of the type described herein are implemented by one or more processors programmed with software to receive a rectangular portion of an image of a scene of real world captured by a camera (which therefore implements means for receiving). Some embodiments of the type described herein may be further implemented by one or more processors programmed with software to use the rectangular portion to determine whether a predetermined test is satisfied (which therefore implements means for using). Certain embodiments of the type described herein may be further implemented by one or more processors programmed with software to implement an OCR decoder, that identifies characters from blocks (which therefore implements means for character decoding). Some embodiments of the type described herein may be further implemented by one or more processors programmed with software to use the rectangular portion to implement a word decoder, to output a first word comprising and confidence level associated with the word (which therefore implements means for word decoding).

Various adaptations and modifications may be made without departing from the scope of the described embodiments. Therefore, numerous modifications and adaptations of the embodiments described herein are encompassed by the appended claims.

1. A method to identify words of text in images, the method comprising:
receiving a rectangular portion of an image of a scene of real world captured by a camera;
using the rectangular portion to determine whether a predetermined test is satisfied;
when the predetermined test is not satisfied, operating an OCR decoder on a block, and storing in a first hypothesis in memory, first candidates for recognition as a character in the block;
when the predetermined test is satisfied, operating one or more OCR decoders, and storing in the first hypothesis the first candidates to be recognized as the character in the block, and predetermined amount additionally storing second candidates to be recognized as the character in a second hypothesis
using a word decoder, to output a first word comprising at least one first candidate in the first hypothesis, and a first confidence level associated with the first word; and
using the word decoder a second time, to output a second word comprising at least one second candidate in the second hypothesis, and a second confidence level associated with the second word;
storing in memory, one of the first word and the second word identified as being recognized in the rectangular portion, based on at least comparison of the first confidence level and the second confidence level;
wherein at least the receiving, the checking, and the storing are performed by at least one processor.

2. The method of claim 1 wherein:
the predetermined test comprises a predetermined limit on an attribute of the block.

3. The method of claim 2 wherein:
the attribute is aspect ratio.

4. The method of claim 1 wherein:
the at least one first candidate is a normal character in a predetermined language; and
the at least one second candidate is a compound character formed by combining a left-most part of a first consonant with a second consonant.

5. The method of claim 4 wherein:
when the predetermined test is satisfied, a first OCR decoder is operated on the block and a second OCR decoder is additionally operated on the block; and
wherein when the predetermined test is not satisfied, the second OCR decoder is operated on the block.

6. The method of claim 1 wherein:
the predetermined test comprises checking if a lower maatra is present in the rectangular portion.

7. The method of claim 6 further comprising:
preparing a cropped image, by removing at least the lower maatra in a copy of the rectangular portion;
the rectangular portion is hereinafter uncropped image;
wherein when the predetermined test is satisfied, the OCR decoder is operated on a first block extracted from the uncropped image and the OCR decoder is additionally operated on a second block extracted from the cropped image; and
wherein when the predetermined test is not satisfied, the OCR decoder is operated on the first block extracted from the uncropped image.

8. The method of claim 1 wherein:
when the predetermined test is not satisfied, a first OCR decoder is operated on the block, wherein the first OCR decoder is configured to recognize characters with the property that does not satisfy the test based on a first limit, the first limit being obtained by increasing a predetermined limit by a predetermined amount;
when the predetermined test is satisfied, a second OCR decoder is operated on the block, wherein the second OCR decoder is configured to recognize the characters with the property that satisfies the test based on a second limit, the second limit being obtained by reducing the predetermined limit by said predetermined amount.

9. At least one non-transitory computer readable storage media comprising a plurality of instructions to be executed by at least one processor to identify words of text in an image of a scene of real world, the plurality of instructions comprising:
instructions to receive a rectangular portion of an image of a scene of real world captured by a camera;
instructions to use the rectangular portion to determine whether a predetermined test is satisfied;
when the predetermined test is not satisfied, instructions to operate an OCR decoder on a block, and instructions to store in a first hypothesis in memory, first candidates for recognition as a character in the block;
when the predetermined test is satisfied, instructions to operate one or more OCR decoders, and storing in the first hypothesis the first candidates to be recognized as the character in the block, and additionally storing second candidates to be recognized as the character in a second hypothesis
instructions to use a word decoder, to output a first word comprising at least one first candidate in the first hypothesis, and a first confidence level associated with the first word; and
instructions to use the word decoder a second time, to output a second word comprising at least one second candidate in the second hypothesis, and a second confidence level associated with the second word;
instructions to store in memory, one of the first word and the second word identified as being recognized in the rectangular portion, based on at least comparison of the first confidence level and the second confidence level.

10. The at least one non-transitory computer readable storage media of claim 9 wherein:
the predetermined test comprises a predetermined limit on an attribute of the block.

11. The at least one non-transitory computer readable storage media of claim 10 wherein:
the attribute is aspect ratio.

12. The at least one non-transitory computer readable storage media of claim 9 wherein:
the at least one first candidate is a normal character in a predetermined language; and
the at least one second candidate is a compound character formed by combining a left-most part of a first consonant with a second consonant.

13. The at least one non-transitory computer readable storage media of claim 9 wherein:
when the predetermined test is satisfied, a first OCR decoder is operated on the block and a second OCR decoder is additionally operated on the block; and
wherein when the predetermined test is not satisfied, the second OCR decoder is operated on the block.

14. The at least one non-transitory computer readable storage media of claim 9 wherein:
the predetermined test comprises checking if a lower maatra is present in the rectangular portion.

15. A mobile device to decode text in real world images, the mobile device comprising:
a camera;
a memory operatively connected to the camera to receive at least an image therefrom, the image comprising one or more text regions;
at least one processor operatively connected to the memory to execute a plurality of instructions stored in the memory;
wherein the plurality of instructions cause the at least one processor to:
receive a rectangular portion of an image of a scene of real world captured by a camera;
use the rectangular portion to determine whether a predetermined test is satisfied;
when the predetermined test is not satisfied, operate an OCR decoder on a block, and storing in a first hypothesis in memory, first candidates for recognition as a character in the block;
when the predetermined test is satisfied, operate one or more OCR decoders, and storing in the first hypothesis the first candidates to be recognized as the character in the block, and additionally storing second candidates to be recognized as the character in a second hypothesis
use a word decoder, to output a first word comprising at least one first candidate in the first hypothesis, and a first confidence level associated with the first word; and
use the word decoder a second time, to output a second word comprising at least one second candidate in the second hypothesis, and a second confidence level associated with the second word;
store in memory, one of the first word and the second word identified as being recognized in the rectangular portion, based on at least comparison of the first confidence level and the second confidence level.

16. The mobile device of claim 15 wherein:
the predetermined test comprises a predetermined limit on an attribute of the block.

17. The mobile device of claim 15 wherein:
the attribute is aspect ratio.

18. The mobile device of claim 15 wherein:
the at least one first candidate is a normal character in a predetermined language; and
the at least one second candidate is a compound character formed by combining a left-most part of a first consonant with a second consonant.

19. A mobile device comprising:
a camera to capture an image of an environment outside the mobile device;
a memory coupled to the camera for storing the image;
means for receiving a rectangular portion of an image of a scene of real world captured by a camera;
means for using the rectangular portion to determine whether a predetermined test is satisfied;
responsive to the predetermined test being not satisfied, means for operating an OCR decoder on a block, and storing in a first hypothesis in memory, first candidates for recognition as a character in the block;
responsive to the predetermined test is satisfied, means for operating one or more OCR decoders, and storing in the first hypothesis the first candidates to be recognized as the character in the block, and additionally storing second candidates to be recognized as the character in a second hypothesis
means for using a word decoder, to output a first word comprising at least one first candidate in the first hypothesis, and a first confidence level associated with the first word; and
means for using the word decoder a second time, to output a second word comprising at least one second candidate in the second hypothesis, and a second confidence level associated with the second word; and
means for storing in memory, one of the first word and the second word identified as being recognized in the rectangular portion, based on at least comparison of the first confidence level and the second confidence level.
